(19) United States
(12) Patent Application Publication
(10) Pub. No.: US 2021/0086217 A1
(43) Pub. Date: Mar. 25, 2021

(54) CONTAINER PROCESSING SYSTEM

(71) Applicant: Toyo Seikan Co., Ltd., Tokyo (JP)

(72) Inventors: Taketoshi Manou, Yokohama-shi (JP); Kouhei Endo, Yokohama-shi (JP); Tomoyuki Miyazaki, Ibaraki City (JP); Keisuke Nyuu, Yokohama-shi (JP); Masaaki Fujitani, Yokohama-shi (JP)

(73) Assignee: Toyo Seikan Co., Ltd., Tokyo (JP)

(21) Appl. No.: 17/114,759

(22) Filed: Dec. 8, 2020

Related U.S. Application Data
(63) Continuation of application No. PCT/JP2019/021048, filed on May 28, 2019.

(30) Foreign Application Priority Data
Jun. 15, 2018 (JP) 2018-114142

(51) Int. Cl. B05B 13/06; B05B 3/10; B05B 7/04; B05B 13/02; B05B 13/04; B05B 15/58

(52) U.S. Cl. CPC B05B 13/0618; B05B 3/10; B05B 7/0416; B05B 13/0278; B05C 7/02; B05B 13/0636; B05B 13/069; B05B 15/58; B05B 13/041

(57) ABSTRACT

Provided is a container processing system that inhibits, a processing liquid that is used to process containers from being attached to peripheral equipment. A container processing system (10) includes a chamber (30) having in an inside thereof a gas flow control chamber (35) and a container processor (40) including container treaters (51) and (61) that perform processing on containers (C). The chamber (30) has container processing openings (36) and (37) making the gas flow control chamber (35) and an outside of the chamber (30) communicate with each other. The container treaters (51) and (61) are configured to perform, from inside the gas flow control chamber (35), processing on the containers (C), which are inserted into the chamber (30) through the container processing openings (36) and (37), or on the containers (C), which is opposed to the container processing openings (36) and (37), outside the chamber (30).

### TECHNICAL FIELD

The present invention relates to a container processing system that performs processing on containers.

### BACKGROUND ART

As a container processing system that performs various processing on containers made of a plastic or the like, a coater for coating an inner wall surface of each of the containers with a coating agent for improving a slipping property of a viscous content, such as a mayonnaise-like food item, is known conventionally (see, e.g., Patent Literature 1).

The coater described in Patent Literature 1 is configured such that a coating agent is ejected from a spray nozzle inserted in the container to coat the inner wall surface of the container with the coating agent.

### CITATION LIST

### Patent Literature

[Patent Literature 1] Japanese Patent No. 5790967

### SUMMARY OF INVENTION

### Technical Problem

However, the coater as described in Patent Literature 1 has a problem in that a misty coating agent ejected and atomized inside each of containers leaks to an outside of the container and is attached to an unintended place such as peripheral equipment.

To solve the problem described above, in the coater described in Patent Literature 1, the misty coating agent in the container is sucked by a aspirator capable of facing an inlet of the container, thereby being inhibited from leaking to the outside of the container. However, it is difficult to completely prevent the misty coating agent from leaking to the outside.

The present invention is intended to solve such a problem, and an object of the present invention is to provide a container processing system that inhibits, with a simple configuration, a processing liquid that is used for processing containers from being attached to peripheral equipment.

### Solution to Problem

The present invention solves the problem described above by providing a container processing system for performing processing on a container, the container processing system including: a chamber having in an inside thereof a gas flow control chamber; and a container processor including a container treater for performing processing on the container, the chamber having a container processing opening making the gas flow control chamber and an outside of the chamber communicate with each other, the container treater being configured to perform, from inside the gas flow control chamber, processing on the container, which is inserted into the chamber through the container processing opening or on the container, which is opposed to the container processing opening, outside the chamber.

### Advantageous Effects of Invention

According to one aspect of the present invention, a chamber having in an inside thereof a gas flow control chamber has a container processing opening making the gas flow control chamber and an outside of the chamber communicate with each other, and the container treater is configured to perform, from inside the gas flow control chamber, processing on a container, which is inserted into the chamber through the container processing opening or on the container, which is opposed to the container processing opening, outside the chamber. By thus performing the processing on the container from a gas flow control chamber side in the chamber, it is possible to prevent a processing liquid to be used for container processing, such as a coating agent, from leaking out into or flying on peripheral equipment. Therefore, it is possible to inhibit the processing liquid from being attached to the peripheral equipment and also inhibit the container processing from being affected by an external environment.

According to another aspect of the present invention, with a aspirator connected to the chamber and configured to suck in a gas in the gas flow control chamber being provided, it is possible to inhibit the misty processing liquid ejected and atomized in the chamber from being attached to an unexpected portion of the container or leaking to an outside of the chamber.

According to another aspect of the present invention, the chamber has, at a position above the container processing opening opened below the chamber, an upwardly-tapered chamber inner surface having a downwardly increasing diameter. This allows the processing liquid attached to the chamber inner surface to be guided toward an outside of the chamber inner surface. Therefore, it is possible to inhibit the processing liquid attached to the chamber inner surface from dropping and being attached to the container inserted in or opposite to the container processing opening.

According to another aspect of the present invention, container processing system further includes an approach tool for causing the chamber and the container to relatively approach each other, thereby inserting the container into the chamber through the container processing opening. The container treater is configured to perform, from inside the gas flow control chamber, the processing on the container inserted into the chamber. As a result, when the container is processed, it is possible to perform the processing on the container in the chamber in a state where the container processing opening is closed by the container. Therefore, it is possible to inhibit the processing liquid, such as the coating agent, from leaking out through the container processing opening.

According to another aspect of the present invention, the container processing opening is formed to have a size that allows only a portion of the container to pass therethrough when the container is inserted. As a result, even when the container is slightly misaligned with the container processing opening when the container is inserted into the container processing opening, it is possible to allow an edge portion of the container processing opening to guide the container and thereby correct a position of the container.

According to another aspect the present invention, the chamber includes a centering guide formed separately from a chamber main body and having the container processing opening. Therefore, it is possible to form the edge portion of the container processing opening of a synthetic resin or the like and smoothly correct the position of the container when the container is inserted into the container processing opening.

According to another aspect of the present invention, the container processing system further includes a aspirator that sucks in the gas in the gas flow control chamber of the chamber, and the container treater is configured to perform, from inside the gas flow control chamber, the processing on the container in a state where at least a portion of the container inserted in a cylindrical section formed in the chamber is located in the cylindrical section. This allows easy control of a gas flow around an outer periphery of the container inserted in the cylindrical section and can therefore inhibit the processing liquid from being attached to an outer surface of the container.

According to another aspect of the present invention, the cylindrical section has a ventilating section formed to take in an outside air into a space between an inner peripheral side of the cylindrical section and an outer peripheral side of the container when the container is inserted in the cylindrical section. As a result, it is possible to avoid a situation in which, due to suction of the gas in the chamber by the aspirator, the container clings to the cylindrical section and also inhibit the processing liquid from being attached to the outer surface of the container due to a gas flow formed between the inner peripheral side of the cylindrical section and the outer peripheral side of the container.

According to another aspect of the present invention, the chamber includes a liquid receptacle section formed at a lower position of the gas flow control chamber. Consequently, it is possible to inhibit the processing liquid stored in the chamber from being attached to the container inserted in or opposed to the container processing opening.

According to another aspect of the present invention, the centering guide inserted into a main body opening of the chamber main body has an inner projecting section disposed to project inside the chamber main body, and the inner projecting section forms a portion of a peripheral wall of the liquid receptacle section. This allows a portion of the centering guide functioning as a portion into which the container is to be inserted when the container is processed to be used as the peripheral wall of the liquid receptacle section. Thus, it is possible to simplify a configuration of the chamber.

According to another aspect of the present invention, the chamber includes a first container processing opening to which the container is opposed or into which the container is inserted when the container is processed by the coater and a second container processing opening to which the container is opposed or into which the container is inserted when the container is processed by the mist collector, the first container processing opening and the second container processing opening communicate in common with the gas flow control chamber, and the container processing system further includes the aspirator that sucks in the gas in the gas flow control chamber. As a result, when coating processing and mist collecting processing is performed using the common aspirator and the common gas flow control chamber, it is possible to inhibit the extra coating agent from being attached to an unexpected portion of the container. Thus, it is possible to simplify a device configuration.

According to another aspect of the present invention, the coater includes a spray nozzle capable of ejecting the coating agent toward the inner wall surface of the container, and the mist collector includes a gas ejection nozzle capable of ejecting the gas into the container. As a result, when the spray nozzle is inserted into the container to coat the inner wall surface of the container with the coating agent, it is possible to inhibit the extra coating agent from being attached to an outer surface of the container. In addition, by causing the aspirator to suck in the gas in the gas flow control chamber while ejecting the gas into the container, it is possible to expel the misty coating agent in the container and successfully collect the misty coating agent.

According to another aspect of the present invention, the aspirator that sucks in the gas in the gas flow control chamber includes a suction hose connected to the chamber, a mist box connected to the suction hose, and a mist collector connected to the mist box and having a filter disposed therein, and the mist box has a baffle plate disposed in an inner space. Accordingly, by allowing the baffle plate to be exposed to the mist including the processing liquid such as the coating agent and collect a liquid component on an upstream side of the mist collector having the filter disposed therein, it is possible inhibit the liquid component in the mist from being delivered into the mist collector. Therefore, it is possible to inhibit the liquid component in the mist from being attached to the filter of the mist collector and reduce the frequency of maintenance such as a filter change.

According to another aspect of the present invention, the coater includes the spray nozzle having a coating agent ejection path, a supply controller for controlling a supply of the coating agent to the coating agent ejection path, and an ejected amount estimator for estimating an amount of the coating agent ejected from the spray nozzle, the supply controller has a coating agent tank, a circulation path connected to the coating agent tank and configured to circulate the coating agent, and an openable/closable valve disposed between the coating agent ejection path and the circulation path, the ejected amount estimator includes a pressure sensor for measuring a variation of a pressure of the coating agent in the circulation path and an estimator connected to the pressure sensor, and the estimator is configured to estimate the amount of the ejected coating agent from an integrated value of pressure drops obtained on the basis of a variation of a pressure value of the coating agent measured by the pressure sensor. This allows the amount of the ejected coating agent to be estimated with a simple configuration. Therefore, it is possible to easily sense occurrence of a problem such as clogging of the spray nozzle.

### BRIEF DESCRIPTION OF DRAWINGS

FIG. 1 is a perspective view illustrating a container processing system according to an embodiment of the present invention.

FIG. 2 is a perspective view illustrating a portion of FIG. 1 in enlarged relation.

FIG. 3 is a perspective view illustrating a portion of FIG. 2 in enlarged relation.

FIG. 4 is an illustrative view illustrating a container conveyer viewed from above.

FIG. 5 is an illustrative view illustrating a state where a container row is moved to a container transfer area.

FIG. 6 is an illustrative view illustrating a state where the container row is moved to a first container processing area.

FIG. 7 is an illustrative view illustrating a state where the container row is disposed in each of the container transfer area and the container processing areas.

FIG. 8 is an illustrative view illustrating a chamber and a container processor each viewed in cross section.

FIG. 9 is an illustrative view illustrating a first step of a container processing method.

FIG. 10 is an illustrative view illustrating a second step of the container processing method.

FIG. 11 is an illustrative view illustrating a third step of the container processing method.

FIG. 12 is an illustrative view illustrating a fourth step of the container processing method.

FIG. 13 is an illustrative view illustrating a fifth step of the container processing method.

FIG. 14 is an illustrative view illustrating a sixth step of the container processing method.

FIG. 15 is an illustrative view schematically illustrating a configuration of a aspirator.

FIG. 16 is an illustrative view schematically illustrating a configuration of a coater.

FIG. 17 is a graph illustrating a method of estimating an amount of an ejected coating agent.

FIG. 18 is an illustrative view illustrating a modification of a ventilation section.

### DESCRIPTION OF EMBODIMENTS

Referring to drawings, a description will be given of a container processing system 10 as an embodiment of the present invention.

First, the container processing system 10 performs various processing on containers C. In the present embodiment, the container processing system 10 performs coating processing of coating an inner wall surface of each of the containers C in which a viscous content, such as a mayonnaise-like food item, is to be contained with a coating agent for improving a slipping property of the content as well as mist collecting processing of collecting mist (such as an atomized coating agent) in each of the containers C.

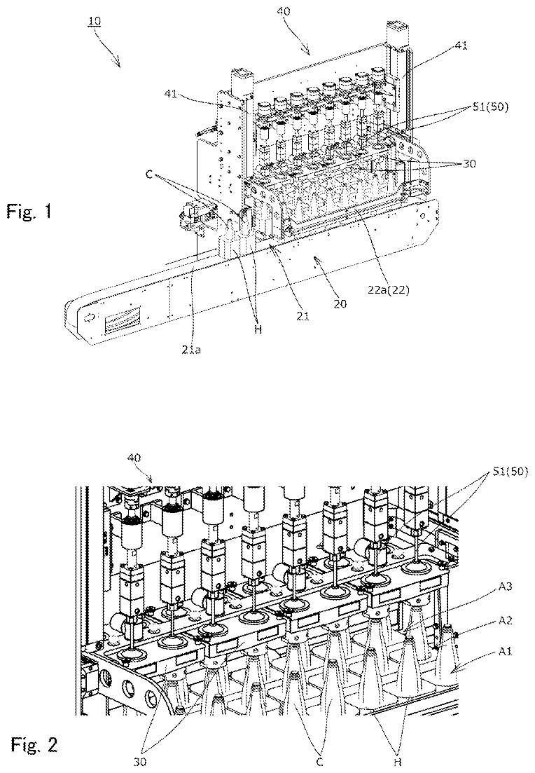

As illustrated in FIG. 1 and the like, the container processing system 10 includes a container conveyer 20 that conveys the containers C, chambers 30 each having a gas flow control chamber 35 in an inside thereof, a container processor 40 including a coater 50 that performs the coating processing on the containers C and a mist collector 60 that performs the mist collecting processing on the containers C, a aspirator 70 connected to each of the chambers 30 to suck in a gas in the gas flow control chamber 35, and a control unit including a PLC having a CPU, a ROM, a RAM, and the like, a personal computer, and the like to control the individual parts.

A specific description will be given below of the individual components of the container processing system 10.

Note that a “container conveyance direction” used in the following description is a direction in which the containers C are conveyed by a container carrier 21 described later, a “container transfer direction” used in the following description is a direction in which the containers C are transferred by container transferrer 22 and 23 described later, and a “container row direction” used in the following description is a direction in which the plurality of containers C are arranged in each of areas A1 to A3 described later.

The container conveyer 20 conveys the containers C being held by upwardly opened container holders H. As illustrated in FIG. 4, the container conveyer 20 includes the container carrier 21 that conveys the containers C arranged in a row along a container conveying path 21a, the first container transferrer 22 that moves a container row including the plurality of containers C arranged in a row in the container transfer area A1 set in a section of the container conveying path 21a (a downstream segment of the container conveying path 21a in the present embodiment) toward the first container processing area A2 where the coating processing is performed on the containers C, the second container transferrer 23 that moves the container row in the first container processing area A2 toward the second container processing area A3 where the mist collecting processing is performed on the containers C, and a lever 24 that feeds the container row in the second container processing area A3 to a downstream side.

As illustrated in FIGS. 1 and 4, the container carrier 21 is formed of a conveyer belt that conveys the containers C arranged in a single row. An upper surface of the conveyer belt forms the linearly extending container conveying path 21a.

As illustrated in FIG. 4, the first container transferrer 22 has a first feeding pusher 22a provided to be movable along the container transfer direction and collectively push and move the container row in the container transfer area A1 toward the first container processing area A2. The first feeding pusher 22a has a feeding surface 22b having a flat surface shape. The feeding surface 22b may also have a shape along outer shapes of the container holders H. In this case, it is also possible to provide the feeding surface 22b with a function of dispersing and positioning the plurality of container holders H in the container row direction.

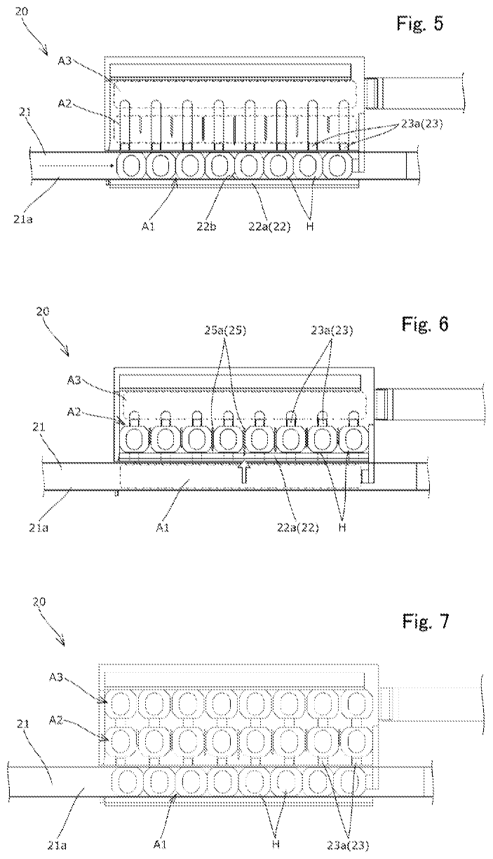

As illustrated in FIG. 4, the second container transferrer 23 includes a plurality of second feeding pushers 23a provided to be movable in the container transfer direction (and in a vertical direction) and push and move the container row in the first container processing area A2 toward the second container processing area A3. As can be seen from FIGS. 5 and 6, the second feeding pusher 23a also has a function of positioning the container row in the container transfer direction when the container row is moved from the container transfer area A1 to the first container processing area A2.

The feeding pushers 22a and 23a and the lever 24 are driven by a drive source including various actuators of an electrically-powered type, a hydraulically-driven type, an air-driven type, and the like, various motors, and the like.

The container conveyer 20 also includes, as components other than those described above, a Guide 25 that positions, in the container row direction, each of the containers C arranged in the row in the first container processing area A2, a container presence/absence sensor 26 disposed around the container conveying path 21a, a container holder number sensor 27 disposed in the vicinity of an entrance of the container transfer area A1, an alignment checking sensor 28 disposed around the container transfer area A1, a container stopper 29A disposed at the entrance of the container transfer area A1, and a stopper 29B disposed at a downstream end of the container transfer area A1 to regulate movement of the containers C to the downstream side, as illustrated in FIG. 4.

As illustrated in FIG. 4, the Guide 25 has a plurality of guide pieces 25a. The plurality of guide pieces 25a are disposed in the first container processing area A2 to be arranged at predetermined intervals along the container row direction.

Each of the guide pieces 25a has a front-side guide end portion 25b located on the container transfer area A1 side. The plurality of guide pieces 25a are formed such that the front-side guide end portion 25b of the guide piece 25a located on an outer side in the container row direction is located at a position more distant from the container transfer area A1 than the front-side guide end portion 25b of the guide piece 25a located on a center side in the container row direction.

The container presence/absence sensor 26 detects whether or not the containers C are held by the respective container holders H conveyed along the container conveying path 21a. When it is detected by the container presence/absence sensor 26 that the containers C are not held by the container holders H, the container processing system 10 is configured to stop operating.

The container holder number sensor 27 counts the number of the container holders H transmitted to the container transfer area A1. The container stopper 29A is configured to stop movement of the container holders H to the container transfer area A1 on the basis of the number of the container holders H counted by the container holder number sensor 27.

The alignment checking sensor 28 checks positions, at which the containers in the container row are aligned, in the container transfer area A1. When it is detected by the alignment checking sensor 28 that the positions in the container transfer area A1 at which the containers in the container row are aligned are out of order, the container processing system 10 is configured to stop operating.

Next, a description will be given below of the chambers 30.

Each of the chambers 30 is disposed to extend between the first container processing area A2 and the second container processing area A3 and perform various processing (the coating processing and the mist collecting processing) on the containers C in an inside thereof. In the present embodiment, as illustrated in FIGS. 1 to 3, the plurality of (four) chambers 30 are disposed to be arranged along the container row direction.

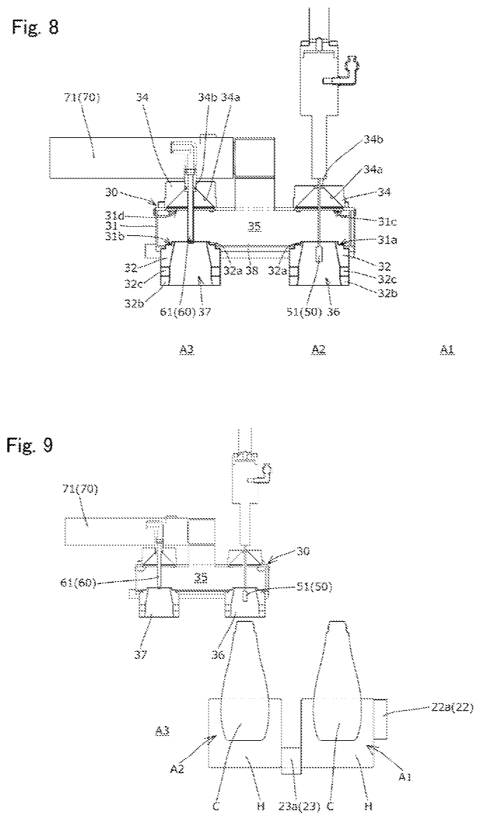

As illustrated in FIG. 8, each of the chambers 30 includes a chamber main body 31 formed of a metal or the like, centering guides 32 formed of a synthetic resin or the like, and attachment caps 34.

As illustrated in FIG. 8 and the like, each of the chamber main bodies 31 has, in a lower surface thereof, a plurality of (two) first main body openings 31a formed to be arranged in the container row direction in the first container processing area A2 and a plurality of (two) second main body openings 31b formed to be arranged in the container row direction in the second container processing area A3 located on a rear side of the first container processing area A2 in the container transfer direction.

As illustrated in FIG. 8 and the like, each of the chamber main bodies 31 also has, in an upper surface thereof, a plurality of (two) third main body openings 31c formed to be arranged in the container row direction in the first container processing area A2 and a plurality of (two) fourth main body openings 31d formed to be arranged in the container row direction in the second container processing area A3.

As illustrated in FIG. 8 and the like, the first main body openings 31a and the third main body openings 31c are formed at positions opposed to each other in the vertical direction, while the second main body openings 31b and the fourth main body openings 31d are formed at positions opposed to each other in the vertical direction.

Each of the centering guides 32 is formed to have a substantially cylindrical shape. As illustrated in FIG. 8 and the like, the centering guides 32 are portions functioning as cylindrical portions inserted in the first main body openings 31a and the second main body openings 31b of the chamber main body 31 to be fixed thereto and allow portions of the containers C to be inserted therein when the containers are processed.

As illustrated in FIG. 8 and the like, each of the centering guides 32 includes an inner projecting section 32a disposed to project inside further inward (upward) of the chamber main body 31 than a bottom wall of the chamber main body 31 and an outer projecting section 32b disposed to project further outward (downward) of the chamber main body 31 than the bottom wall of the chamber main body 31.

As illustrated in FIG. 8 and the like, each of the inner projecting sections 32a forms a portion of a peripheral wall of a liquid receptacle section 38 described later.

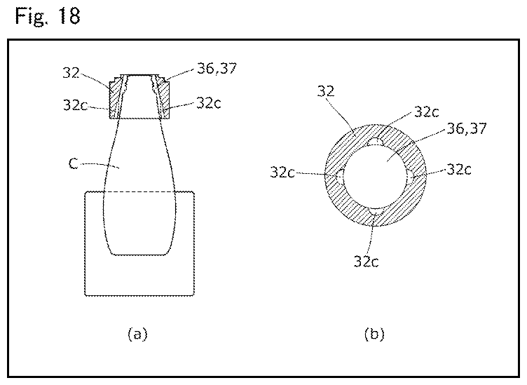

As illustrated in FIG. 8 and the like, each of the outer projecting portions 32b has a ventilation section 32c formed to take in outside air into a space between an inner peripheral side of the centering guide 32 and an outer peripheral side of each of the containers C in a state where the container C is inserted in the centering guide 32. In an example illustrated in FIG. 8 and the like, the ventilation section 32c is formed as a ventilation hole extending through the centering guide 32 between an inside and an outside thereof. The ventilation hole serving as the ventilation section 32c is disposed at a position which provides communication between the inside of the centering guide 32 and an outside of the chamber 30. Note that a specific mode of the ventilation section 32c is not limited to the ventilation hole described above and may be any as long as the ventilation section 32c can take in the outside air into the space between the inner peripheral side of the centering guide 32 and the outer peripheral side of the container C. For example, as illustrated in FIG. 18, the ventilation section 32c may also be recessed portions formed in an inner peripheral surface of the centering guide 32. In an example illustrated in FIG. 18, the plurality of recessed portions serving as the ventilation section 32c are formed equidistantly in a peripheral direction to reach a lower end of the inner peripheral surface of the centering guide 32.

As illustrated in FIG. 8 and the like, each of the centering guides 32 disposed in the first container processing area A2 has an opening, and the opening functions as a first container processing opening 36 into which the container C is to be inserted when the coater 50 performs processing on the container.

As illustrated in FIG. 8 and the like, each of the centering guides 32 disposed in the second container processing area A3 has an opening, and the opening functions as a second container processing opening 37 into which the container C is to be inserted when the mist collector 60 performs processing on the container.

Each of the container processing openings 36 and 37 is formed to be opened below the chamber 30 and provide communication between the gas flow control chamber 35 and the outside of the chamber 30.

As illustrated in FIG. 8 and the like, each of the container processing openings 36 and 37 communicates with the common gas flow control chamber 35.

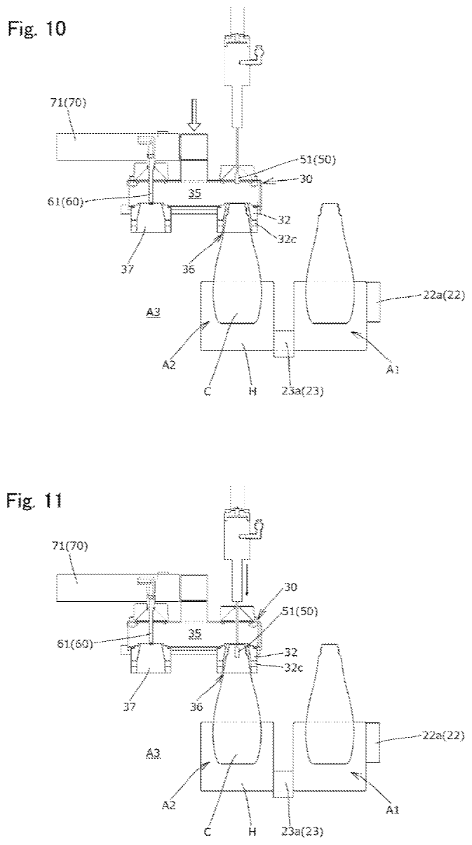

As illustrated in FIG. 10 and the like, each of the container processing openings 36 and 37 is formed to have a size which allows only a portion of the container C (only an upper portion of the container C on a container inlet side) to pass therethrough when the container Cis inserted.

As illustrated in FIG. 8 and the like, the attachment caps 34 are attached to fit into the third main body openings 31c and the fourth main body openings 31d.

Each of the attachment caps 34 has, on a lower surface side thereof facing the gas flow control chamber 35, an upwardly-tapered chamber inner surface 34a having a downwardly increasing diameter at a position above the container processing opening 36 or 37.

The attachment caps 34 have, in center portions thereof, through holes 34b extending through the attachment caps 34 in the vertical direction.

The through holes 34b allow spray nozzles 51 or gas ejection nozzles 61 described later to be inserted therethrough in the vertical direction.

As illustrated in FIG. 8 and the like, each of the chambers 30 has the liquid receptacle section 38 formed at a position below the gas flow control chamber 35 and a duct for discharging a liquid stored in the liquid receptacle section 38 to the outside of the chamber 30.

The liquid receptacle section 38 is a space in the chamber main body 31 capable of storing the coating agent and including the bottom wall and side walls of the chamber main body 31, the inner projecting sections 32a of the centering guides 32, and the like.

The duct connects the chamber main body 31 and a mist box 72 described later.

Next, a description will be given below of the container processor 40.

As illustrated in FIGS. 1, 8, and the like, the container processor 40 includes the coater 50 that coats the inner wall surface of each of the containers C with the coating agent in the first container processing area A2, the mist collector 60 that collects the mist in each of the containers C in the second container processing area A3 set lateral to the first container processing area A2 opposite to the container transfer area A1, and a vertically moving driver 41 serving as an approach tool that causes the chambers 30 and the containers C to relatively approach each other.

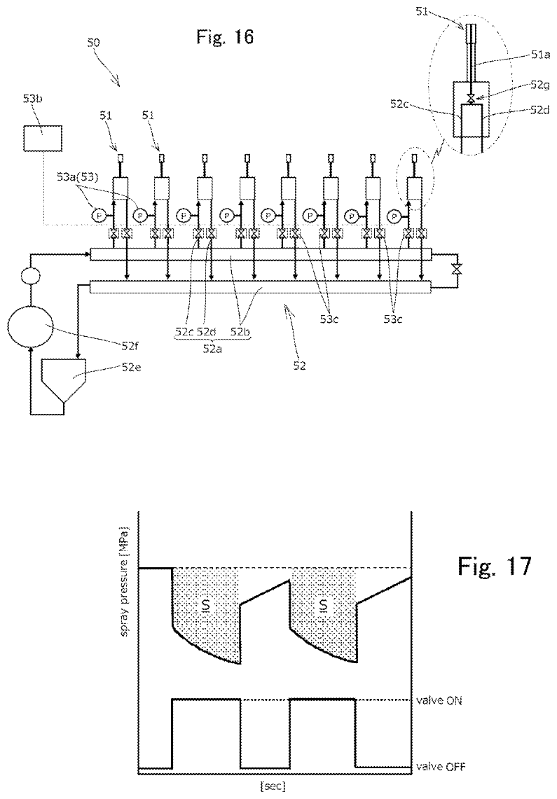

As illustrated in FIGS. 8, 16, and the like, the coater 50 includes the spray nozzles 51 each serving as a container treater capable of ejecting the coating agent toward the inner wall surface of each of the containers C, a supply controller 52 that controls a supply of the coating agent to each of coating agent ejection paths 51a formed in the spray nozzles 51, a nozzle driver that drives the spray nozzles 51, and an ejected amount estimator 53 that estimates an amount of the coating agent ejected from each of the spray nozzles 51.

As illustrated in FIGS. 2, 11, and the like, each of the spray nozzles 51 performs, from inside the gas flow control chamber 35, processing on each of the plurality of containers C disposed to be arranged in the container row direction in the first container processing area A2 and inserted in the chamber 30 through the first main body openings 31a.

Each of the spray nozzles 51 is configured to be movable in the vertical direction by the nozzle driver and rotatable around an axial line of the spray nozzle 51. As illustrated in FIG. 11 and the like, the spray nozzle 51 is configured to be inserted into the container C through the through hole 34b of the attachment cap 34 when the coating processing is performed and coat the inner wall surface of the container C with the coating agent for improving a slipping property of a content thereof, while being vertically moved and rotated in the container C.

Note that, during the coating processing, the gas in the gas flow control chamber 35 is sucked by the aspirator 70, and consequently the extra coating agent flown from the container C is sucked to be removed.

The nozzle driver drives the spray nozzles 51 and includes various actuators of an electrically-powered type, a hydraulically-driven type, and an air-driven type, various motors, and the like.

As illustrated in FIG. 16, the supply controller 52 has circulation paths 52a that circulate the coating agent, a coating agent tank 52e, a pump 52f, and openable/closable valves 52g.

As illustrated in FIG. 16, each of the circulation paths 52a includes a main pipe line 52b provided to be shared by the plurality of spray nozzles 51 and an out-going path 52c and an in-coming path 52d which are formed for each of the spray nozzles 51 and connected to the main pipe line 52b.

The coating agent tank 52e and the pump 52f are connected to the main pipe lines 52b, while the valves 52g are disposed between the coating agent ejection paths 51a and the circulation paths 52a (the out-going paths 52c and the in-coming paths 52d).

The supply controller 52 is configured such that, when the coating processing is performed, the valves 52g which are in a closed state at normal times are opened to supply the coating agent circulating in the circulation paths 52a to the coating agent ejection paths 51a through use of a pressure of the coating agent in the circulation paths 52a and cause the spray nozzles 51 to eject the coating agent.

The ejected amount estimator 53 has pressure sensors 53a that measure a variation of the pressure of the coating agent in each of the circulation paths 52a, an estimator 53b connected to the pressure sensors 53a, and throttle valves 53c that regulate flow rates of the coating agent.

In the present embodiment, as illustrated in FIG. 16, the pressure sensors 53a are attached to the individual out-going paths 52c so as to measure the variation of the pressure of the coating agent in each of the out-going paths 52c.

The estimator 53b includes a PLC having a CPU, a ROM, a RAM, and the like, a personal computer, and the like to estimate an amount of the ejected coating agent from an integrated value (i.e., an area value of each of portions S illustrated in FIG. 17) of pressure drops from before ejection at a time when the coating agent is ejected (when the valves 52g are set to ON) from each of the spray nozzles 51, which has been obtained on the basis of a variation of a pressure value of the coating agent measured by each of the pressure sensors 53a.

Then, the estimator 53b compares the integrated value of the pressure drops (estimated value of the amount of the ejected coating agent) to a preset threshold to sense occurrence of a problem such as clogging of the spray nozzle 51.

The throttle valves 53c are provided on an upstream side of the pressure sensor 53a in each of the out-going paths 52c and in each of the in-coming paths 52d. By regulating the flow rate of the coating agent using the throttle valves 53c, even when an extremely small amount of the coating agent is applied, a pressure drop when the coating agent is ejected is increased to allow easier estimation of the amount of the ejected coating agent.

FIG. 17 represents the variation of the pressure value of the coating agent measured by each of the pressure sensors 53a when the coating agent is ejected from the spray nozzle 51.

The pressure value before the ejection of the coating agent remains at a given value but, as soon as the ejection is started, the pressure value significantly decreases and then gradually decreases during the ejection. Then, when the ejection is stopped, the pressure value returns to the value before the ejection.

At this time, the integrated value of the pressure drops (area value of each of the portions S in FIG. 17) and the amount of the ejected coating agent have a correlationship therebetween. Consequently, it is possible to estimate the amount of the ejected coating agent from the area value of the portion S.

When the amount of the ejected coating agent decreases due to clogging of the spray nozzle 51 or the like, a pressure drop when the coating agent is ejected decreases, and accordingly the area value of the portion S decreases.

Therefore, by monitoring the area value of the portion S, it is possible to sense abnormality in the amount of the ejected coating agent.

As a conventional technique, there is a method which detects a pressure value with given timing during the ejection of the coating agent to sense abnormality in the ejected amount. However, when abnormality occurs in the ejected amount during the ejection, it is possible that the conventional method cannot sense the abnormality depending on the timing of detecting the pressure value.

According to the method in the present embodiment, it is possible to estimate a coating amount using the integrated value of the pressure drops during the ejection. Therefore, even when abnormality occurs in the coating amount during the ejection, it is possible to precisely sense the abnormality.

As illustrated in FIG. 8 and the like, the mist collector 60 includes the gas ejection nozzles 61 serving as the container treater capable of ejecting a gas into each of the containers C. The mist collector 60 is configured to insert each of the gas ejection nozzles 61 into the container C subjected to the coating processing performed in a state where the gas in the gas flow control chamber 35 is sucked by the aspirator 70 to eject the gas such as air into the container C and thus expel and remove the extra misty coating agent from inside the container C.

The plurality of gas ejection nozzles 61 are disposed to be arranged in the container row direction in the second container processing area A3 to perform, from inside the gas flow control chamber 35, processing on the containers C inserted in the chamber 30 through the second container processing openings 37.

As illustrated in FIG. 8 and the like, each of the gas ejection nozzles 61 is inserted into the chamber 30 through the through hole 34b of the attachment cap 34 and attached in a fixed state to the chamber 30 to have a tip portion thereof disposed in the chamber 30.

The vertically moving driver 41 includes various actuators of an electrically-powered type, a hydraulically-driven type, and an air-driven type, various motors, and the like. The vertically moving driver 41 moves each of the chambers 30 along the vertical direction. The vertically moving driver 41 is configured to move the chamber 30 downward and thereby cause the containers C to be inserted into the chamber 30 through the container processing openings 36 and 37.

Note that the gas ejection nozzles 61 attached to the chamber 30, suction hoses 71, and the like are also configured to be vertically moved by the vertically moving driver 41.

Next, a description will be given of the aspirator 70.

The aspirator 70 sucks in the gas in the gas flow control chamber 35 of each of the chambers 30. As illustrated in FIGS. 8, 15, and the like, the aspirator 70 includes the suction hoses 71 connected to the chambers 30, the mist box 72 connected to the suction hoses 71, and a mist collector 73 connected to the mist box 72 and having a filter disposed therein.

The suction hoses 71 are connected individually to the plurality of (four) chambers 30 disposed to be arranged along the container row direction. All the suction hoses 71 are connected to the mist box 72.

As illustrated in FIG. 15, the mist box 72 has an inner space 72a and a baffle plate 72b disposed in the inner space 72a.

The baffle plate 72b regulates a flow of the mist in the inner space 72a and the baffle plate 72b itself is exposed to the mist containing the coating agent to separate the mist into a liquid and a gas.

The gas resulting from the separation by the baffle plate 72b is discharged to an outside of the inner space 72a through a duct connected to the mist box 72.

The liquid resulting from the separation by the baffle plate 72b is delivered to a discharged liquid collection box through the duct connected to the mist box 72.

The mist collector 73 is also connected to the discharged liquid collection box through the duct. The liquid separated by a filter in the mist collector 73 is delivered to the discharged liquid collection box.

Next, a description will be given of a container processing method to be implemented by the container processing system 10 in the present embodiment. Note that, for easy understanding of the container processing method, the following will describe processing performed on one container row with time.

First, the containers C being held by the container holders H are arranged in a row and conveyed by the container carrier 21 along the container conveying path 21a toward the container transfer area A1.

Next, as illustrated in FIG. 5, the predetermined number of (eight in the present embodiment) containers C are fed into the container transfer area A1, and then the container stopper 29A is closed. As illustrated in FIG. 6, the plurality of containers C fed into the container transfer area A1 are pushed out by the first feeding pusher 22a of the first container transferrer 22 to be moved from the container transfer area A1 to the first container processing area A2.

At this time, in the first container processing area A2, the plurality of guide pieces 25a are disposed to be arranged at predetermined intervals along the container row direction. Therefore, it is possible to insert, between the guide pieces 25a, the containers C (container holders H) pushed out by the first feeding pusher 22a toward the first container processing area A2 and thereby determine the respective positions of the individual containers C (container holders H) in the container row direction.

Next, as illustrated in FIG. 10, the chamber 30 is moved downward by the vertically moving driver 41 to insert the upper portion of the container C into the first container processing opening 36 of the chamber 30.

At this time, the first container processing opening 36 is formed to have a size which allows only a portion of the container C (only the upper portion of the container C on the container inlet side) to pass therethrough, and the container C is held by the container holder H, while having allowance in a horizontal direction. Consequently, even when there is a slight displacement between a center of the first container processing opening 36 and a center of the container C in the horizontal direction, it is possible to cause an edge portion of the first container processing opening 36 to guide the container C in the horizontal direction and center the container C with respect to the first container processing opening 36.

Next, as illustrated in FIG. 11, the spray nozzle 51 of the coater 50 is moved downward to be inserted into the container C and apply the coating agent to the inner wall surface of the container C, while being vertically moved and rotated (positively/negatively rotated at a predetermined angle) in the container C.

At this time, since the aspirator 70 has sucked in the gas in the gas flow control chamber 35, the extra coating agent is sucked to be removed.

Also, as illustrated in FIG. 11, in the centering guide 32, the ventilation section 32c is formed at the position which provides communication between the inside of the centering guide 32 and the outside of the chamber 30, and it is possible to take in outside air into the space between the inner peripheral side of the centering guide 32 and the outer peripheral side of the container C through the ventilation section 32c. Therefore, it is possible to avoid a situation in which, due to the suction of the gas in the chamber 30 by the aspirator 70, the container C clings to an inner peripheral portion of the centering guide 32 and also inhibit the processing liquid such as the coating agent from being attached to an outer surface of the container C due to a gas flow formed between the inner peripheral side of the centering guide 32 and the outer peripheral side of the container C.

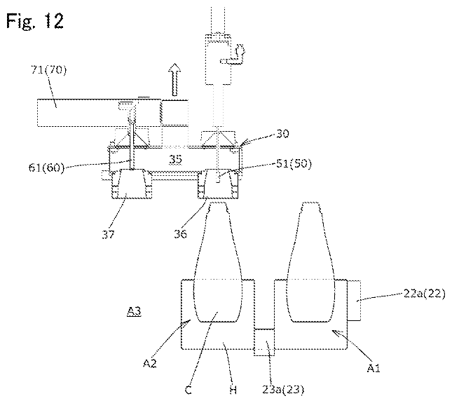

Next, as illustrated in FIG. 12, the chamber 30 is moved upward by the vertically moving driver 41 to cause the container C to relatively come off through the first container processing opening 36 of the chamber 30.

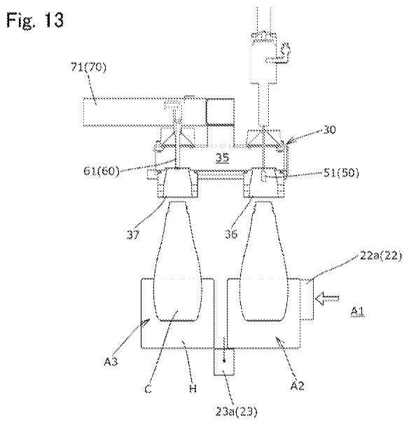

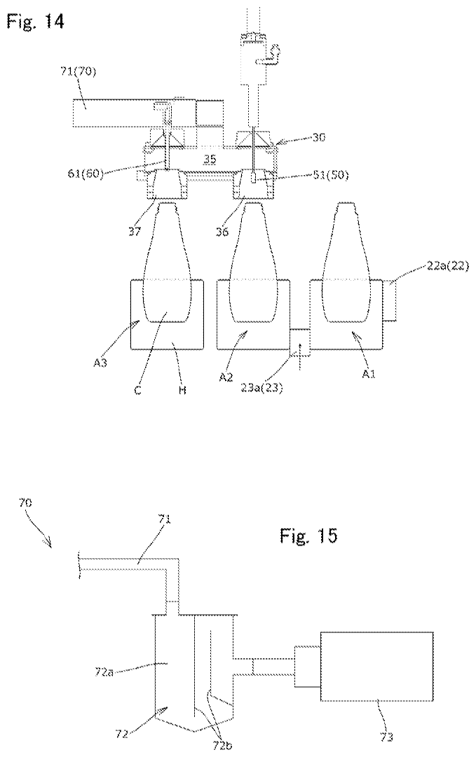

Next, as can be seen from FIGS. 12 and 13, the plurality of containers C arranged in the container row direction in the container transfer area A1 are pushed out by the second feeding pusher 23a of the second container transferrer 23 to be moved from the first container processing area A2 into the second container processing area A3.

Next, the chamber 30 is moved downward by the vertically moving driver 41 to insert the upper portion of the container C into the second container processing opening 37 of the chamber 30 and also insert the gas ejection nozzle 61 of the mist collector 60 into the container C.

Next, in a state where the gas in the gas flow control chamber 35 is sucked by the aspirator 70, a gas such as air is ejected from the gas ejection nozzle 61 to expel and remove the extra misty coating agent from inside the container C.

Next, by the vertically moving driver 41, the chamber 30 and the gas ejection nozzle 61 are moved upward to extract the gas ejection nozzle 61 from inside the container C and also relatively extract the container C through the second container processing opening 37 of the chamber 30.

Finally, using the lever 24, the plurality of containers C arranged in a row in the second container processing area A3 are pushed out to a downstream side.

Note that, for easier understanding of the container processing method, the processing performed on one container row has been described above with time. However, as a specific mode of the container processing method, as illustrated in FIGS. 1, 2, and 7, the coating processing and the mist collecting processing may also be simultaneously performed on different container rows.

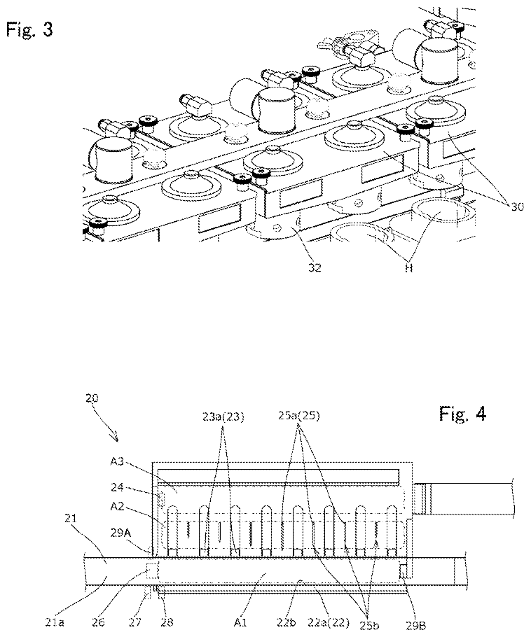

In FIGS. 3 and 5 to 7, for easy understanding of a configuration of each of the parts, the illustration of the container C is omitted.

While the embodiment of the present invention has been described heretofore in detail, the present invention is not limited to the embodiment described above. Various design modifications can be made without departing from the present invention described in appended claims.

For example, the embodiment described above explains that the container processor 40 performs the coating processing and the mist collecting processing. However, specific details of the processing performed on the containers C by the container processor 40 are not limited to those described above. For example, the container processor 40 may also be configured so as to perform cleaning processing on the containers C. In this case, the processing liquid to be sprayed onto the containers C is cleaning water such as water.

Also, the embodiment described above explains that each of the containers C is a plastic container to be filled with a viscous content such as a mayonnaise-like food item. However, a specific mode of the container C and a use purpose thereof may be any.

Also, the embodiment described above explains that the container processing system 10 is configured to perform, in the chambers 30, various processing on the containers C inserted in the chambers 30 through the container processing openings 36 and 37. However, the container processing system 10 may also be configured to perform, from inside the gas flow control chamber 35, various processing on the containers C opposed to the container processing openings 36 and 37 outside the chambers 30 without inserting the containers C into the chambers 30.

Also, the embodiment described above explains that the container processing openings 36 and 37 are formed to be opened below the chambers 30. However, the container processing openings 36 and 37 may be opened in any direction. For example, the container processing openings 36 and 37 may also be formed to be opened laterally to the chambers 30 or formed to be opened above the chambers 30.

Also, in the embodiment described above, it is assumed that the approach tool is formed of the vertically moving driver 41 that vertically moves the chambers 30 and the like. However, a specific mode of the approach tool may be any as long as the approach tool allows the chambers 30 and the containers C to relatively approach each other. For example, the approach tool may be configured to move the containers C and thus cause the chambers 30 and the containers C to relatively approach each other or may also be configured to move both of the containers C and the chambers 30 and thus cause the chambers 30 and the containers C to relatively approach each other.

The direction in which the chambers 30 or the containers C are moved by the approach tool is also not limited to the vertical direction.

Also, in the embodiment described above, it is assumed that the container carrier 21 is formed of the conveyer belt. However, a specific mode of the container carrier 21 may be any as long as the container carrier 21 can convey the containers C. For example, the container carrier 21 may also use a turret or the like.

Also, in the embodiment described above, it is assumed that the container transferrer 22 and 23 use the feeding pushers 22a and 23a to transfer the containers C. However, the specific mode of the container transferrer 22 and 23 may be any as long as the container transferrer 22 and 23 can transfer the container C. For example, the container transferrer 22 and 23 may also hold the containers C and move the containers C in the container transfer direction.

Also, in the embodiment described above, it is assumed that the containers C are arranged in the single row and conveyed along the container conveying path 21a. However, the containers C may also be arranged in a plurality of two or more rows and conveyed along the container conveying path 21a.

Also, in the embodiment described above, it is assumed that the container conveyer 20 conveys the containers C being held by the container holders H. However, the container conveyer 20 may also be configured to directly handle the containers C which are not held by the container holders H.

Also, in the embodiment described above, it is assumed that the spray nozzles 51 are movable by the nozzle driver relative to the chambers 30. However, similarly to the gas ejection nozzles 61, the spray nozzles 51 may also be disposed in a fixed state with respective to the chambers 30.

Similarly to the spray nozzles 51, the gas ejection nozzles 61 may also be configured to be movable by the nozzle driver relative to the chambers 30.

Also, in the embodiment described above, it is assumed that the container row direction and the container conveyance direction are parallel with each other, and each of the container row direction and the container conveyance direction and the container transfer direction are perpendicular to each other. However, the container row direction and the container conveyance direction may also be set non-parallel with each other or, alternatively, the container transfer direction may also be set to cross each of the container row direction and the container conveyance direction at an angle other than 90°.

### REFERENCE SIGNS LIST

10 Container processing system
20 Container conveyer
21 Container carrier
21a Container conveying path
22 First container transferrer
22a First feeding pusher
22b Feeding surface
23 Second container transferrer
23a Second feeding pusher
24 Lever
25 Guide
25a Guide piece
25b Front-side guide end portion
26 Container presence/absence sensor
27 Container holder number sensor
28 Alignment checking sensor
29A Container stopper
29B Stopper
30 Chamber
31 Chamber main body
31a First main body opening
31b Second main body opening
31c Third main body opening
31d Fourth main body opening
32 Centering guide (cylindrical section)
32a Inner projecting section
32b Outer projecting section
32c Ventilation section
34 Attachment cap
34a Chamber inner surface
34b Through hole
35 Gas flow control chamber
36 First container processing opening
37 Second container processing opening
38 Liquid receptacle section
40 Container processor
41 Vertically moving driver (approach tool)
50 Coater
51 Spray nozzle (container treater)
51a Coating agent ejection path
52 Supply controller
52a Circulation path
52b Main pipe line
52c Out-going path
52d In-coming path
52e Coating agent tank
52f Pump
52g Valve
53 Ejected amount estimator
53a Pressure sensor
53b Estimator
53c Throttle valve
60 Mist collector
61 Gas ejection nozzle (container treater)
70 Aspirator
71 Suction hose
72 Mist box
72a Inner space
72b Baffle plate
73 Mist collector
A1 Container transfer area
A2 First container processing area
A3 Second container processing area
C Container
H Container holder

1. A container processing system for performing processing on a container, the container processing system comprising:
a chamber having in an inside thereof a gas flow control chamber; and
a container processor including a container treater for performing processing on the container,
the chamber having a container processing opening making the gas flow control chamber and an outside of the chamber communicate with each other,
the container treater being configured to perform, from inside the gas flow control chamber, processing on the container which is inserted into the chamber through the container processing opening, or on the container which is opposed to the container processing opening outside the chamber.

2. The container processing system according to claim 1, further comprising an aspirator connected to the chamber and configured to suck in a gas in the gas flow control chamber.

3. The container processing system according to claim 1, wherein
the container processing opening is formed to be opened below the chamber, and
the chamber has, at a position above the container processing opening, an upwardly-tapered chamber inner surface having a downwardly increasing diameter.

4. The container processing system according to claim 1, further comprising an approach tool for causing the chamber and the container to relatively approach each other, thereby inserting the container into the chamber through the container processing opening, wherein
the container treater is configured to perform, from inside the gas flow control chamber, the processing on the container inserted into the chamber.

5. The container processing system according to claim 4, wherein the container processing opening is formed to have a size that allows only a portion of the container to pass therethrough when the container is inserted.

6. The container processing system according to claim 5, wherein the chamber includes a chamber main body and a centering guide attached to the chamber main body and having the container processing opening.

7. The container processing system according to claim 4, further comprising an aspirator connected to the chamber and configured to suck in the gas in the gas flow control chamber, wherein
the chamber has a cylindrical section, and
the container treater is configured to perform, from inside the gas flow control chamber, the processing on the container in a state where at least a portion of the container inserted by the approach tool into the cylindrical section is located in the cylindrical section.

8. The container processing system according to claim 7, wherein the cylindrical section has a ventilating section formed to take in an outside air into a space between an inner peripheral side of the cylindrical section and an outer peripheral side of the container when the container is inserted in the cylindrical section.

9. The container processing system according to claim 1, wherein the chamber includes a liquid receptacle section formed at a lower position of the gas flow control chamber.

10. The container processing system according to claim 9, wherein
the chamber includes the chamber main body having a main body opening, and a centering guide inserted into the main body opening and having the container processing opening,
the centering guide has an inner projecting section disposed to project inside the chamber main body, and
the inner projecting section forms a portion of a peripheral wall of the liquid receptacle section.

11. The container processing system according to claim 1, wherein
the container processor includes a coater for coating an inner wall surface of the container with a coating agent and a mist collector for collecting mist in the container,
the chamber includes, as the container processing opening, a first container processing opening to which the container is opposed or into which the container is inserted when the container is processed by the coater and a second container processing opening to which the container is opposed or into which the container is inserted when the container is processed by the mist collector, and
the first container processing opening and the second container processing opening communicate in common with the gas flow control chamber,
the container processing system further comprising an aspirator connected to the chamber and configured to suck in the gas in the gas flow control chamber.

12. The container processing system according to claim 11, wherein
the coater includes, as the container treater, a spray nozzle capable of ejecting the coating agent toward the inner wall surface of the container, and
the mist collector includes, as the container treater, a gas ejection nozzle capable of ejecting the gas into the container.

13. The container processing system according to claim 1, further comprising an aspirator connected to the chamber and configured to suck in the gas in the gas flow control chamber, wherein
the aspirator includes a suction hose connected to the chamber, a mist box connected to the suction hose, and a mist collector connected to the mist box and having a filter disposed therein, and
the mist box has an inner space and a baffle plate disposed in the inner space.

14. The container processing system according to claim 1, wherein
the container processor includes a coater for coating the inner wall surface of the container with a coating agent,
the coater includes a spray nozzle having a coating agent ejection path, a supply controller for controlling supply of the coating agent to the coating agent ejection path, and an ejected amount estimator for estimating an amount of the coating agent ejected from the spray nozzle,
the supply controller has a coating agent tank, a circulation path connected to the coating agent tank and configured to circulate the coating agent, and an openable/closable valve disposed between the coating agent ejection path and the circulation path,
the ejected amount estimator includes a pressure sensor for measuring a variation of a pressure of the coating agent in the circulation path and an estimator connected to the pressure sensor, and
the estimator is configured to estimate the amount of the ejected coating agent from an integrated value of pressure drops obtained on the basis of a variation of a pressure value of the coating agent measured by the pressure sensor.
